(19) United States
(12) Patent Application Publication
(10) Pub. No.: US 2008/0056219 A1
(43) Pub. Date: Mar. 6, 2008

(54) BROADBAND WIRELESS ACCESS NETWORK AND METHODS FOR JOINING MULTICAST BROADCAST SERVICE SESSIONS WITHIN MULTICAST BROADCAST SERVICE ZONES

(76) Inventor: Muthaiah Venkatachalam, Beaverton, OR (US)

Correspondence Address: SCHWEGMAN, LUNDBERG & WOESSNER, P.A., P.O. BOX 2938, MINNEAPOLIS, MN, 55402, US

(21) Appl. No.: 11/468,210

(22) Filed: Aug. 29, 2006

(51) Int. Cl. H04B 7/216

(52) U.S. Cl. 370/342

(57) ABSTRACT

Embodiments of a wireless access network and method for providing multicast broadcast services within multicast broadcast service zones are generally described herein. Other embodiments may be described and claimed. In some embodiments, a multicast broadcast service controller within a network gateway creates a multicast broadcast service zone of base stations by establishing time and frequency parameters for simultaneous multicast downlink transmissions to mobile stations within the MBS zone.

### PRIORITY CLAIMS

The present application claims priority to co-pending U.S. patent application Ser. No. 11/464,438, filed Aug. 14, 2006, entitled “BROADBAND WIRELESS ACCESS NETWORK AND METHOD FOR PROVIDING MULTICAST BROADCAST SERVICES WITHIN MULTICAST BROADCAST SERVICE ZONES”, and to co-pending U.S. patent application Ser. No. 11/464,449, filed Aug. 14, 2006, entitled “BROADBAND WIRELESS ACCESS NETWORK AND METHOD FOR INTERNET PROTOCOL (IP) MULTICASTING,” both of which are incorporated herein by reference.

### TECHNICAL FIELD

The present invention pertains to wireless communication systems. Some embodiments relate to wireless access networks, such as broadband wireless access (BWA) networks. Some embodiments relate to the transmission of multicast broadcast data in wireless access networks. Some embodiments relate to internet protocol (IP) multicasting using an internet group management protocol (IGMP).

### BACKGROUND

In some conventional wireless access networks, each base station independently communicates with associated mobile stations. Each mobile station generally communicates with one base station at a time and may receive broadcast content from that one base station. In these conventional networks, broadcast content is generally transmitted to mobile stations on a per station basis.

One problem with these conventional networks is that is difficult for a mobile station to join a multicast session. Another problem with these conventional networks is that when a mobile station roams between base stations, a handover is performed. The handover may interrupt the flow of the broadcast content. Another problem with these conventional networks is that a mobile station is unable to take advantage of diversity gain because it receives broadcast content from a single base station. Another problem with some of these conventional networks is that a mobile station must process every downlink frame to determine whether or not content is directed to the mobile station.

Thus, there are general needs for wireless access networks and methods that allow mobile stations to easily join multicast sessions. There are also general needs for wireless access networks and methods that allow mobile stations to perform handovers among base stations without interrupting the flow of the broadcast content. There are general needs for wireless access networks and methods that allow mobile stations to take advantage of diversity gain. There are also general needs for wireless access networks and methods that do not require a mobile station to process every downlink frame thereby reducing the mobile station's power consumption.

### BRIEF DESCRIPTION OF THE DRAWINGS

FIG. 1 illustrates a broadband wireless access network in accordance with some embodiments of the present invention;

FIG. 2A illustrates downlink and uplink subframes in accordance with some embodiments of the present invention;

FIG. 2B illustrates downlink and uplink subframes in accordance with some alternate embodiments of the present invention;

FIG. 3 illustrates an end-to-end (E2E) architecture of a broadband wireless access network in accordance with some embodiments of the present invention;

FIG. 4 is a layer 3 (L3) procedure for joining an existing multicast session by a mobile station in accordance with some embodiments of the present invention;

FIG. 5 is a layer 2 (L2) procedure for joining an existing multicast session by a mobile station in accordance with some embodiments of the present invention; and

FIG. 6 illustrates the scheduling, aggregation and synchronization of transmissions by an MBS controller in accordance with some embodiments of the present invention.

### DETAILED DESCRIPTION

The following description and the drawings sufficiently illustrate specific embodiments of the invention to enable those skilled in the art to practice them. Other embodiments may incorporate structural, logical, electrical, process, and other changes. Examples merely typify possible variations. Portions and features of some embodiments may be included in, or substituted for, those of other embodiments. Embodiments of the invention set forth in the claims encompass all available equivalents of those claims. Embodiments of the invention may be referred to herein, individually or collectively, by the term “invention” merely for convenience and without intending to limit the scope of this application to any single invention or inventive concept if more than one is in fact disclosed.

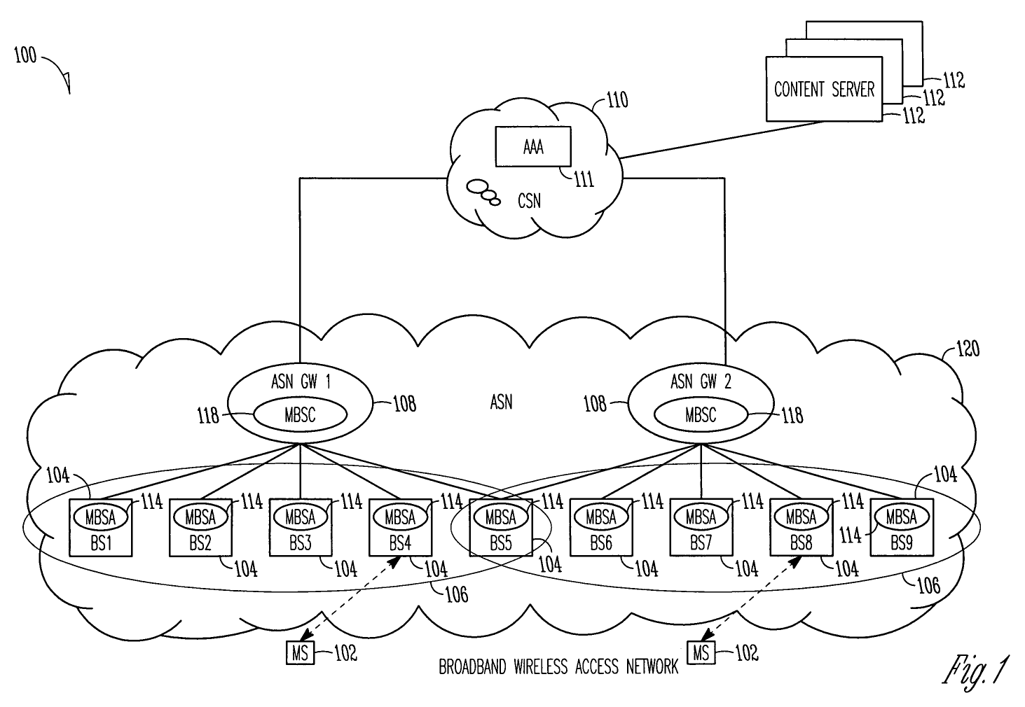

FIG. 1 illustrates a broadband wireless access network in accordance with some embodiments of the present invention. Wireless access network 100 comprises core service network (CSN) 110 and access service network (ASN) 120. Among other things, wireless access network 100 may receive content from one or more content servers 112 and may provide the content to one or more mobile stations (MS) 102. ASN 120 may include one or more gateways (GW) 108, illustrated as ASN GW 1 and ASN GW 2, and a plurality of base stations (BS) 104, illustrated as BS1 through BS9. CSN 110 may include authentication authorization accounting (AAA) server 111 which, among other things, may handle requests for access. As discussed in more detail below, AAA server 111 of CSN 110 may include a policy function to authorize mobile stations 102 to receive multicast broadcast services.

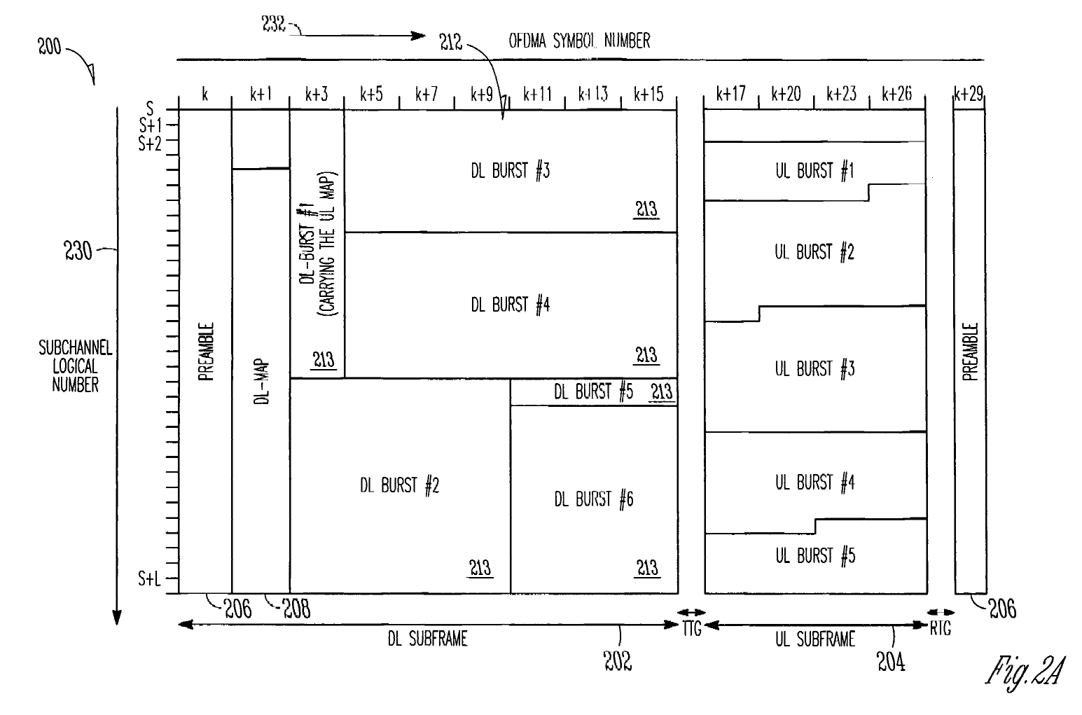

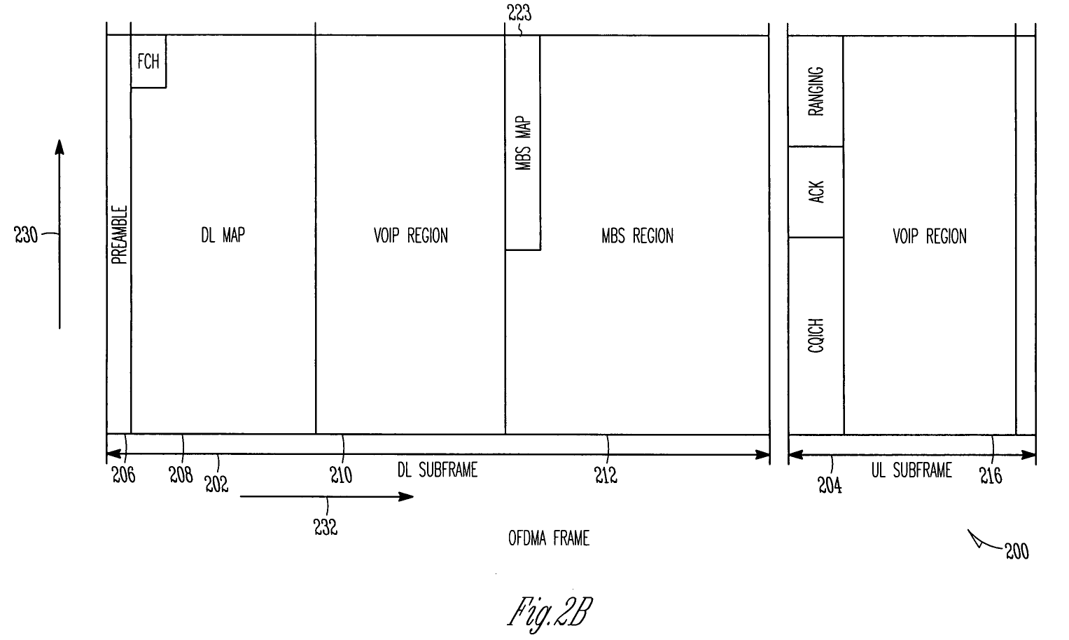

In accordance with embodiments, gateways 108 may include a multicast broadcast service controller (MBSC) 118. Each MBSC 118 may create one or more multicast broadcast service (MBS) zones 106, and each MBS zone 106 may comprise a plurality of base stations 104. MBSCs 118 may create MBS zones 106 by establishing specific time and frequency parameters for simultaneous multicast downlink transmissions to mobile stations 102 within a particular one of MBS zones 106. In these embodiments, base stations 104 may include MBS agents (MBSA) 114 to cause and/or instruct base stations 104 to synchronously transmit identical content within MBS regions of downlink subframes. The identical MBS regions may include multicast broadcast content identified by multicast connection identifiers (CIDs). Multicast broadcast services that may be provided by wireless access network 100 are discussed in more detail below. The MBS regions of downlink subframes are illustrated in FIGS. 2A and 2B, which are discussed in more detail below.

In some embodiments, ASN 120 may also include a session description protocol (SDP) proxy. In these embodiments, mobile station 102 may use primitives of the SDP to contact the SDP proxy and browse the current contents of a multicast session directory within CSN 110, although the scope of the invention is not limited in this respect.

In some embodiments, wireless access network 100 may operate as a single-frequency network (SFN). In these embodiments, base stations 104 of a common MBS zone 106 may have their downlink and/or uplink subframes synchronized in both time and frequency, allowing mobile stations 102 to receive multicast broadcast content from any base station 104 of a particular MBS zone 106 without having to perform handover operations within an MBS zone. In these embodiments, mobile stations 102 may take advantage of diversity gain achieved by receiving signals concurrently from more than one base station 104 of an MBS zone 106, which may result in an improved signal-to-noise ratio (SNR) at the mobile station 102. In these embodiments, multicast broadcast content may be provided within identical MBS regions of downlink subframes, allowing mobile stations 102 to receive broadcast content from any one or more of base stations 104 of an MBS zone 106. These embodiments are described in more detail below.

In some alternate embodiments, one or more non single-frequency network (non-SFN) base stations (not illustrated) outside MBS zone 106 may transmit the multicast data non-synchronously, although the scope of the invention is not limited in this respect. In these embodiments, each base station 104 may operate independently.

FIG. 2A illustrates downlink and uplink subframes in accordance with some embodiments of the present invention. FIG. 2B illustrates downlink and uplink subframes in accordance with some alternate embodiments of the present invention. As illustrated in FIG. 2A, MBS region 212 comprises a plurality of downlink (DL) bursts 213. Each downlink burst 213 may contain multicast broadcast content with a common CID. MBS regions 212 transmitted by base stations of a MBS group, such as MBS zone 106 (FIG. 1), may have an identical burst structure allowing mobile stations 102 to receive the same multicast broadcast content from any base station 104 of an MBS group.

As illustrated in FIGS. 2A and 2B, downlink (DL) subframe 202 and uplink (UL) subframe 204 may be part of frame 200, which may be an orthogonal frequency division multiple access (OFDMA) frame. Downlink subframe 202 may be transmitted by one or more of base stations 104 (FIG. 1) for receipt by one or more mobile stations 102 (FIG. 1). Uplink subframe 204 may be transmitted by mobile stations 102 (FIG. 1) within an assigned uplink time slot. Downlink subframe 202 may include preamble 206, downlink map 208, Voice-over-IP (VoIP) region 210, and MBS region 212, among other things. Uplink subframe 204 may include an acknowledgement and management portions and VoIP region 216, among other things.

In accordance with embodiments of the present invention, MBS region 212 may be used to transmit multicast data to mobile stations 102 (FIG. 1) as discussed above. In these embodiments, each MBS region 212 transmitted by a base station 104 (FIG. 1) within a common MBS zone, such as one of MBS zones 106 (FIG. 1), may be identical and may be synchronized in both time and frequency. MBS region 212 is a portion of downlink subframe 202. In some embodiments, MBS region 212 may comprise most or all of downlink subframe 202. In these embodiments, a group of two or more base stations 104 (FIG. 1) of MBS zone 106 (FIG. 1) may be configured to transmit downlink subframes 202 with identical content within their MBS regions 212.

The downlink and uplink subframes illustrated in FIGS. 2A and 2B may comprise a plurality of subchannels illustrated on frequency axis 230. Each subchannel may comprise a group or set of individual subcarriers, such as orthogonal frequency division multiplexed (OFDM) subcarriers. The downlink and uplink subframes illustrated in FIGS. 2A and 2B may also comprise a plurality of symbols (k) in FIG. 2A on time axis 232. In some embodiments, the basic transmission unit for a downlink subframe may comprise two symbols on a single subchannel, and the basic transmission unit for an uplink subframe may comprise three symbols on a single subchannel, although the scope of the invention is not limited in this respect.

As illustrated in FIGS. 2A and 2B, downlink map 208 may include a frame control header (FCH). As illustrated in FIG. 2B, MBS region 212 may include MBS map 223 defining the structure of MBS region 212. As illustrated in FIG. 2A, a first downlink burst (DL burst #1) may include an uplink map defining the structure of uplink subframe 204. The structures of downlink subframe 202 and uplink subframe 204 illustrated in FIGS. 2A and 2B are meant to convey various example configurations, although the scope of the invention is not limited to either configuration.

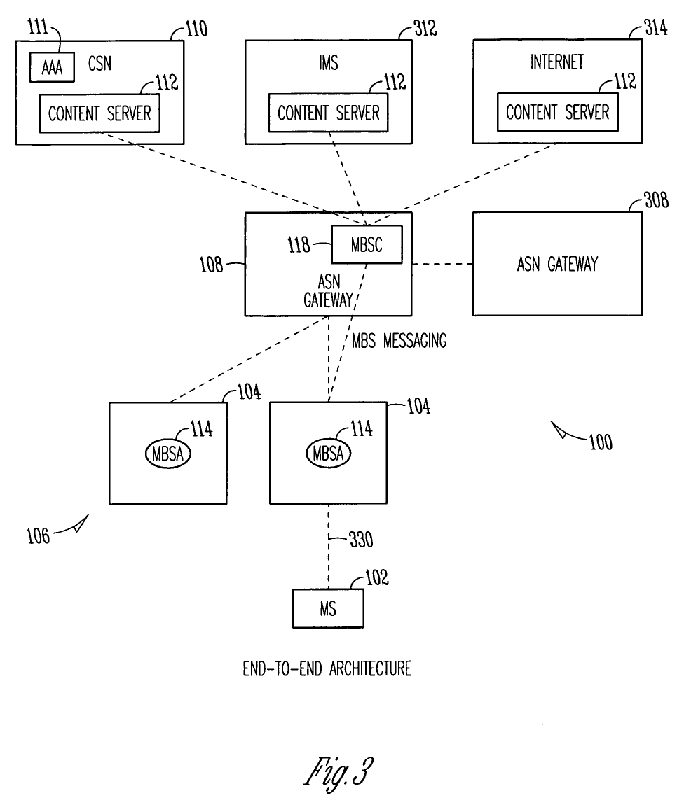

FIG. 3 illustrates an end-to-end (E2E) architecture of a broadband wireless access network in accordance with some embodiments of the present invention. The E2E architecture illustrated in FIG. 3 may be suitable for wireless access network 100 (FIG. 1). As illustrated in FIG. 3, MBSC 118 resides in ASN gateway 108, and in some embodiments, may control one or more MBS zones 106. In embodiments where there is no ASN gateway present in the ASN, such as ASN 120 (FIG. 1), MBSC 118 may be a stand-alone entity within the ASN. In accordance with embodiments, MBSC 118 may perform aggregations, transmissions, scheduling and synchronizations for broadcasting data in MBS zones 106 it controls. MBSC 118 may also create MBS zones, delete MBS zones, and modify properties of existing MBS zones. As illustrated in FIG. 3, MBSAs 114 reside in base stations 104. MBSAs 114 may transmit MBS content over air interface 330 in a synchronized fashion to mobile stations 102 as discussed above, and may assist MBSC 118 in management and control operations.

As illustrated in FIG. 3, content servers 112 may provide broadcast content and may reside in CSN 110, internet protocol (IP) multimedia subsystem (IMS) network 312 and/or Internet 314. The broadcast content may include, for example, music and/or video streaming, although the scope of the invention is not limited in this respect. In some embodiments, content servers 112 may feed MBS content to MBSC 118, which may serve as a focal point for further downlink transmissions within a wireless access network, such as wireless access network 100 (FIG. 1). In some embodiments, MBSC 118 may coordinate with MBSAs 114 of MBS zone 106 to ensure time and frequency synchronization of multicast broadcast content within MBS zone 106.

In some embodiments, several content servers 112 may feed multiple broadcast channels into a single MBS zone. In these embodiments, MBSC 118 may aggregate the content in a timely manner and feed the aggregated content to MBSAs 114. The operations of MBSC 118 are described in more detail below. As illustrated in FIG. 3, ASN gateway 108 may interface with other ASN gateways, such as ASN gateway 308. As illustrated in FIG. 3, CSN 110 may include AAA 111.

In some embodiments, an MBSC may be located within CSN 110, rather than within ASN 120 (FIG. 1). In these embodiments, the MBSC within CSN 110 may control a larger MBS zone, such as a large nationwide zone for national TV programming. In this way, it may be more scaleable and efficient to have an MBSC in a core service network portion of the operators network.

Referring to FIGS. 1 and 3 together, in some embodiments, wireless access network 100 may use IP multicast techniques as part of its SFN operations. In these embodiments, MBSC 118 may be part of an IP multicast group and may receive broadcast content from the IP multicast group.

In some embodiments, IP multicast may be used within MBS zone 106. In these embodiments, for each MBS zone 106, MBSC 118 may set up a local IP multicast group to transmit the multicast broadcast content. In these embodiments, MBSC 118 may provide the multicast IP address for the MBS zone 106 to MBSAs 114 using the MBS primitives described below. These MBS primitives may include requests (REQs), responses (RSPs) and confirms (CNF).

Some examples of MBS primitives include: MBS-join-REQ, which may be sent from an MBSC to an MBSA; MBS-join-RSP, which may be sent from an MBSA to an MBSC; MBS-join-CNF, which may be sent from an MBSC to an MBSA; MBS-leave-REQ, which may be sent from an MBSA to an MBSC; MBS-leave-RSP, which may be sent from an MBSC to an MBSA; MBS-modify-REQ, which may be sent from an MBSC to an MBSA and vice versa; and MBS-modify-RSP, which may be sent from an MBSC to an MBSA and vice versa.

MBS operations performed by MBSC 118 for an MBS control path may include MBS zone creation, deletion, and/or modification. In addition, as part of the MBS operations, an MBSA may join an MBS zone when a mobile station joins, and an MBSA may leave an MBS zone when a mobile station leaves.

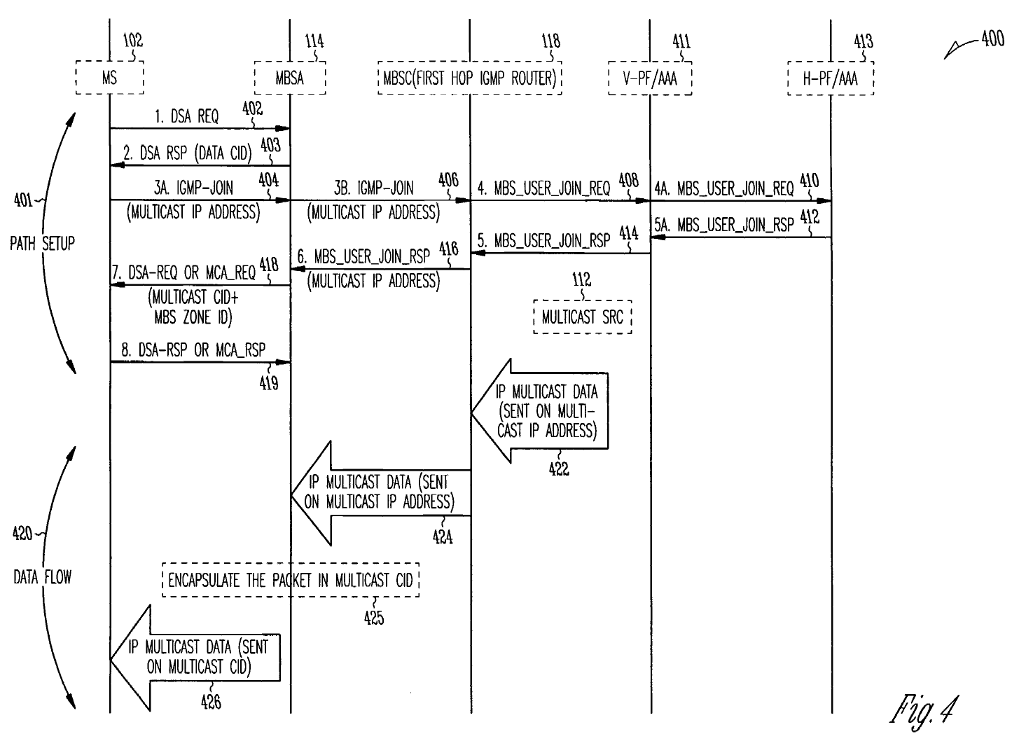

FIG. 4 is a layer 3 (L3) procedure for joining an existing multicast session by a mobile station in accordance with some embodiments of the present invention. Procedure 400 includes path setup portion 401 and data flow portion 420. In path setup portion 401, a data path is set up to allow mobile station (MS) 102 to receive multicast data 422 from a multicast source as described in more detail below. In data flow portion 420, multicast data 422 is routed through MBSC 118 to MBSA 114 to mobile station 102 in accordance with path setup portion 401. In some embodiments, MBSC 118 may be a first hop internet group management protocol (IGMP) router within an ASN gateway. These embodiments are described in more detail below.

As part of path setup portion 401, mobile station 102 may send a dynamic service addition request message (DSA-REQ), such as DSA-REQ 402, to MBSA 114 of the serving base station to obtain a data connection identifier (CID). The data CID may be provided by MBSA 114 in a dynamic service addition response message (DSA-RSP), such as DSA-RSP 403. Messages 402 and 403 are an optional part of procedure 400 and may be performed when a mobile station does not already have a CID.

When mobile station 102 wishes to join an existing multicast session, mobile station 102 may send a request to join message, such as IGMP join message 404, requesting to join a multicast session. The request to join message may be received on an open data CID, such as the data CID discussed above, and the request to join message may include a multicast IP address of the existing multicast session or group that mobile station 102 is requesting to join. In these embodiments, message 404 may be a network layer communication at L3.

Prior to transmitting the request to join message, mobile station 102 may have been allowed to browse the contents of a session directory stored on a directory server within ASN 120 (FIG. 1) to determine the multicast IP address of the multicast session that mobile station 102 wishes to join. Mobile station 102 may include the IP address in request to join message 404. A multicast session directory may list multicast sessions that are currently ‘ON’ in the Internet and/or that may be scheduled for future transmission.

Message 404 may be forwarded as IGMP join message 406 to an ASN gateway which may have IGMP router functionality. When the serving base station does have IGMP router functionality, it may perform the operations of an IGMP router.

In response to IGMP join message 406, MBSC 118 may send MBS user join request message 408 to a policy function (PF) of an AAA server, such as visitor PF/AAA server 411. Visitor PF/AAA server 411 may identify the home PF for mobile station 102 based on the IP address of mobile station 102. Visitor PF/AAA server 411 may forward MBS user join request message 410 to home PF/AAA server 413. Home PF/AAA server 413 may determine if the mobile station is authorized to receive MBS and may reply with MBS user join response message 412 to visitor PF/AAA server 411. MBS user join response message 412 may, for example, either indicate that the mobile station is authorized to receive MBS service, or that the mobile station is not authorized to receive MBS. Visitor PF/AAA server 411 may forward MBS user join response message 414 to MBSC 118. When authorized, MBSC 118 may send MBS user join response message 416 with the multicast IP address to MBSA 114, and MBSA 114 may send service addition request message 418 to mobile station 102. In some embodiments, service addition request message 418 may be a dynamic service addition request (DSA-REQ) message or a multicast allocation request (MCA REQ) message. Service addition request message 418 may include the multicast CID and the MBS zone ID. The MBS zone ID may indicate MBS zone 106 (FIG. 1). Service addition request message 418 may also include an encryption key for decrypting the MBS content when it is encrypted. Mobile station 102 may send response message 419, which may be a dynamic service addition response (DSA-RSP) message or a multicast allocation response (MCA-RSP) message.

In these embodiments, mobile station 102 may have IGMP functionality, such as IGMP v3 stack, although the scope of the invention is not limited in this respect. In some of these embodiments, mobile station 102 may form a leaf node of an IP multicast distribution tree, although the scope of the invention is not limited in this respect. Each MBS zone may have an MBS zone ID. At layer 2, each MBS zone or each channel in a zone may be mapped to multicast CID. In some embodiments, an entire MBS zone may be mapped to a multicast IP address. In some alternate embodiments, a particular channel of the MBS zone may be mapped to a multicast IP address. Mobile station 102 may know or may have determined the multicast IP address of the zone/channel to which mobile station 102 wishes to receive or subscribe. In some embodiments, a zone/channel directory that includes a corresponding multicast IP address mapping may be available to mobile stations either via a web server at CSN 110 (FIG. 1) or via usage of the SDP proxy discussed above. As shown in FIG. 4, a trigger for joining the multicast session may come from IGMP join message 404 sent on a data CID by mobile station 102.

As part of data flow portion 420, IP multicast data 422, may be sent on a multicast IP address from a multicast source (Src), such as one of content servers 112 (FIG. 1), and may be routed by MBSC 118 to serving base station 104 as IP multicast data 424. MBSA 114 of the serving base station, in operation 425, may encapsulate the packets in the multicast CID established above for transmission to mobile station 102 as IP multicast data 426. In some embodiments, IP multicast data 426 may be transmitted to one or more mobile stations that are part of the current multicast session. These mobile stations may be associated with the same base station or may be associated with different base stations.

In some embodiments, the multicast CID may be created as a new multicast CID when mobile station 102 is a first mobile station served by MBSA 114 requesting to join the multicast session. In these embodiments, MBSA 114 may refrain from creating a new multicast CID for use in mapping packets to the multicast IP address when one or more other mobile stations currently being served by MBSA 114 are part of the multicast session. In these embodiments, MBSA 114 may provide an existing multicast CID to mobile station 102 within message 418.

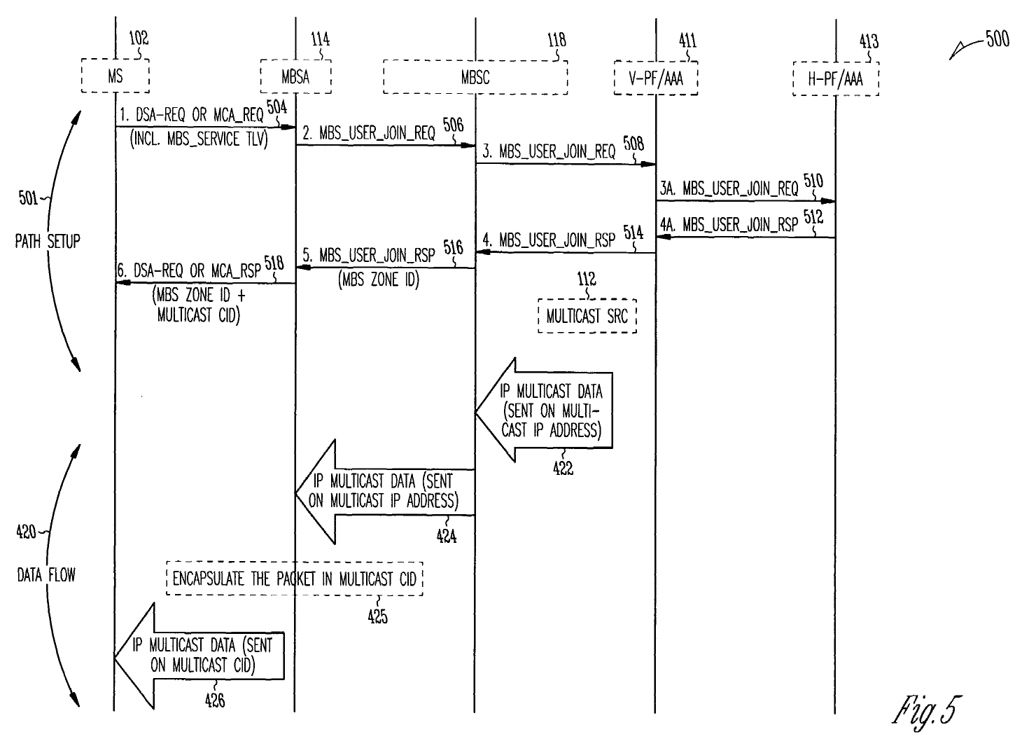

FIG. 5 is a layer 2 (L2) procedure for joining an existing multicast session by a mobile station in accordance with some embodiments of the present invention. Procedure 500 includes path setup portion 501 and data flow portion 420. In path setup portion 501, a data path is set up to allow mobile station (MS) 102 to receive multicast data 422 from a multicast source (Src), such as one of content servers 112 (FIG. 1). In data flow portion 420, multicast data 422 is routed through MBSC 118 to MBSA 114 to mobile station 102 in accordance with path setup portion 501. In path setup portion 501, mobile station 102 joins an MBS session and a layer 2 connection is set up to the mobile station.

In these embodiments, mobile station 102 may not necessarily have an IGMP v3 stack. As a result, mobile station 102 may be dependent on MAC layer signaling to become part of an MBS zone. In these embodiments, each MBS zone may have an MBS zone ID. At L2, each MBS zone, such as MBS zone 106 (FIG. 1), or each channel in an MBS zone, may be mapped to a multicast CID. In these embodiments, a zone/channel directory and the corresponding multicast CID/MBS zone-ID mapping may be available to a mobile station via a web server at CSN 110 (FIG. 1). As illustrated in FIG. 5, a trigger to join an MBS session may come from mobile station 102 which requests MBS service by including the MBS service type-length-value (TLV) in a L2 MAC message, shown as message 504. Message 504 may, for example, be a DSA-REQ message or a MCA-REQ message. Alternatively, the serving base station may initiate the service flow by sending a DSA-REQ message. In these embodiments, mobile station 102 may not know the multicast CID to include in message 504. In some of these embodiments, message 504 may be a dynamic link layer (DLL) communication at L2.

In response to receipt of message 504, MBSA 114 sends MBS user join request message 506 to MBSC 118. In response to MBS user join request message 506, MBSC 118 may send MBS user join request message 508 to a PF of an AAA server, such as visitor PF/AAA server 411. Visitor PF/AAA server 411 may forward MBS user join request message 510 to home PF/AAA server 413. Home PF/AAA server 413 may authorize the mobile station to receive MBS and may reply with MBS user join response message 512. Visitor PF/AAA server 411 may forward MBS user join response message 514 to MBSC 118. When the mobile station is authorized to receive MBS, MBSC 118 may send MBS user join response message 516 to MBSA 114. Join response message 516 may include the MBS zone ID. MBSA 114 may send service addition request message 518 to mobile station 102. In some embodiments, service addition request message 518 may be a DSA-REQ message or a MCA REQ message. Service addition request message 518 may include the multicast CID and the MBS zone ID. Service addition request message 518 may also include an encryption key for decrypting the MBS content when it is encrypted. In some embodiments, service addition request message 518 may also include a content descriptor describing the MBS content.

Procedures 400 (FIG. 4) and 500 (FIG. 5) may be performed within both non-SFN networks and SFN networks. In non-SFN embodiments, the operations of procedure 400 and/or 500 performed by MBSA 114 may be performed by the serving base station and the operations performed by MBSC 118 may be performed by an ASN gateway.

In some embodiments, mobile stations may switch between MBS zones. As illustrated in FIG. 1, each MBS zone 106 may be a group of base stations 104 with MBSAs 114. When a mobile station leaves one base station and moves to another, the MBS zone may no longer be available. In such a case, the mobile station may switch to a new MBS zone that may be available at the new base station. In such a case, the mobile station may initiate either procedure 400 at level 3, or procedure 500 at level 2 to join the MBS provided by the new base station as discussed above.

In some embodiments, a mobile station may move to a new base station when the mobile station is in idle mode. In these embodiments, if the mobile station wishes to switch to a new MBS zone of the new base station, the mobile station may exit idle mode and re-enter the network. The mobile station may then register with the network and may initiate either procedure 400 at level 3, or procedure 500 at level 2 to join the MBS provided by the new base station as discussed above.

In some embodiments, a mobile station may explicitly leave an MBS zone. In these embodiments, a procedure at either layer 2 or layer 3 may be performed, which may be similar to either procedure 400 at level 3, or procedure 500 at level 2. At layer 3, the mobile station may send an L3 IGMP leave message to MBSA 114. At layer 2, the mobile station may use MAC type messages.

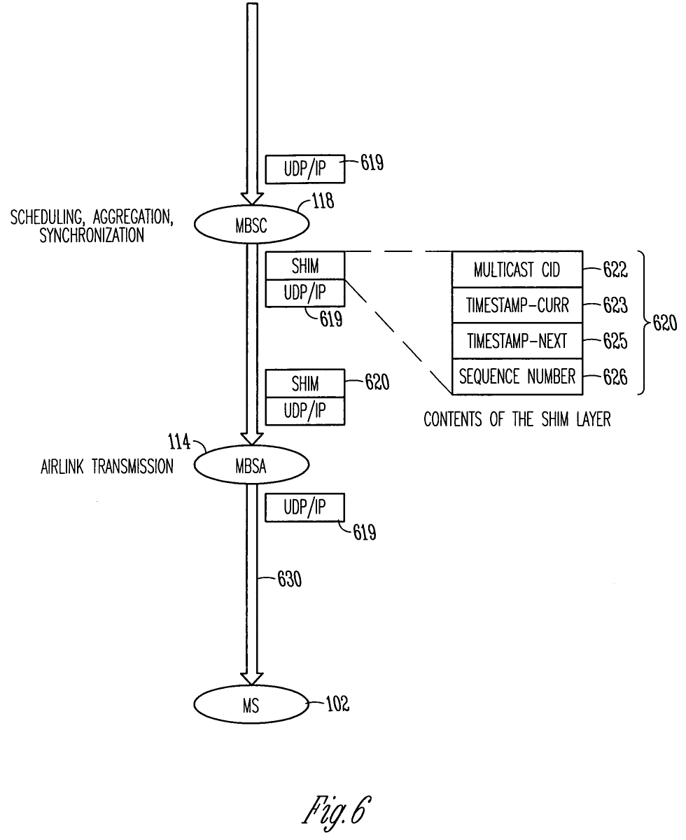

FIG. 6 illustrates the scheduling, aggregation and synchronization of transmissions by an MBS controller in accordance with some embodiments of the present invention. As illustrated in FIG. 6, MBSC 118 receives data packets 619, which may be universal datagram protocol (UDP)/IP data packets, although the scope of the invention is not limited in this respect. Data packets 619 may be received from an upstream source, such as one of content servers 112 (FIG. 1), and may comprise broadcast content of one or more different channels. Since data packets from the different channels are subsequently synchronized in time and frequency within MBS zone 106 (FIG. 1) when transmitted on air interface 630 by MBSAs 114, MBSC 118 adds shim layer 620 to the data packets before providing the data packets to MBSAs 114. MBSAs 114 may use the information in shim layer 620 to synchronize their transmissions. Shim layer 620 is removed by MBSAs 114 before transmission over air interface 630.

In some embodiments, shim layer 620 may include multicast CID 622, which may be the CID on which the packet is transmitted over air interface 630. Shim layer 620 may also include timestamp current (Timestanp_current) 623, which may indicate the future transmission time or transmission frame number of MBS region 212 (FIG. 2A and FIG. 2B) in which this packet is sent. Shim layer 620 may also include timestamp next (Timestamp_next) 625, which may indicate the future transmission time or transmission frame number of the MBS region in which the next packet for this multicast CID will be sent. This information may be transmitted by MBSA 114 within MBS MAP 223 (FIG. 2B) to help a mobile station conserve power. In some embodiments, the mobile station, such as mobile station 102, may remain in idle mode until the next packet transmission occurs, which may be at timestamp next 625. In these embodiments, a mobile station in idle mode does not have to wake up every frame. Shim layer 620 may also include sequence number 626, which may be a sequence number for the data packet. Because there may be multiple packets transmitted in a particular MBS region, MBSAs 114 may use sequence number 626 to order the packets prior to transmission. In this way, identical content and structure are maintained within MBS regions 212 transmitted by MBSAs 114 of two or more base stations 104 (FIG. 1).

Referring to FIG. 1, in some embodiments, base stations 104 and mobile stations 102 may communicate orthogonal frequency division multiplexed (OFDM) communication signals over a multicarrier communication channel. The multicarrier communication channel may be within a predetermined frequency spectrum and may comprise a plurality of orthogonal subcarriers. In some embodiments, the multicarrier signals may be defined by closely spaced OFDM subcarriers. In some wireless access network embodiments, base stations 104 and mobile stations 102 may communicate in accordance with a multiple access technique, such as OFDMA, although the scope of the invention is not limited in this respect. In some embodiments, wireless access network 100 may comprise a BWA network, such as a Worldwide Interoperability for Microwave Access (WiMax) network, although the scope of the invention is not limited in this respect.

In some embodiments, mobile stations 102 may be part of a portable wireless communication device, such as a personal digital assistant (PDA), a laptop or portable computer with wireless communication capability, a web tablet, a wireless telephone, a wireless headset, a pager, an instant messaging device, a digital camera, an access point, a television, a medical device (e.g., a heart rate monitor, a blood pressure monitor, etc.), or other device that may receive and/or transmit information wirelessly.

In some embodiments, the frequency spectrums for the communication signals between base stations 104 and mobile stations 102 may comprise frequencies between 2 and 11 GHz, although the scope of the invention is not limited in this respect. In some wireless access network embodiments, base stations 104 and mobile stations 102 may communicate in accordance with the IEEE 802.16-2004 and the IEEE 802.16(e) standards for wireless metropolitan area networks (WMANs) including variations and evolutions thereof, although the scope of the invention is not limited in this respect as they may also be suitable to transmit and/or receive communications in accordance with other techniques and standards. For more information with respect to the IEEE 802.16 standards, please refer to “IEEE Standards for Information Technology—Telecommunications and Information Exchange between Systems”—Metropolitan Area Networks—Specific Requirements—Part 16: “Air Interface for Fixed Broadband Wireless Access Systems,” May 2005 and related amendments/versions.

Unless specifically stated otherwise, terms such as processing, computing, calculating, determining, displaying, or the like, may refer to an action and/or process of one or more processing or computing systems or similar devices that may manipulate and transform data represented as physical (e.g., electronic) quantities within a processing system's registers and memory into other data similarly represented as physical quantities within the processing system's registers or memories, or other such information storage, transmission or display devices. Furthermore, as used herein, a computing device includes one or more processing elements coupled with computer-readable memory that may be volatile or non-volatile memory or a combination thereof.

Some embodiments of the invention may be implemented in one or a combination of hardware, firmware and software. Some embodiments of the invention may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read-only memory (ROM), random-access memory (RAM), magnetic disk storage media, optical storage media, flash-memory devices, electrical, optical, acoustical or other form of propagated signals (e.g., carrier waves, infrared signals, digital signals, etc.), and others.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims.

In the foregoing detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim. Rather, as the following claims reflect, invention may lie in less than all features of a single disclosed embodiment. Thus, the following claims are hereby incorporated into the detailed description, with each claim standing on its own as a separate preferred embodiment.

What is claimed is:

1. A wireless access network to provide multicast broadcast service (MBS) comprising:
a multicast broadcast service controller (MBSC) to create an MBS zone comprising a plurality of base stations by establishing time and frequency parameters for simultaneous multicast downlink transmissions from the plurality of base stations to mobile stations within the MBS zone; and
an MBS agent (MBSA) within each of the base stations to synchronously transmit identical MBS regions within downlink subframes, the identical MBS regions including multicast data identified by multicast connection identifiers (CIDs),
wherein the MBSC adds a shim layer to multicast packets received from content servers, the shim layer to include a multicast CID, a current timestamp, a next timestamp, and a packet sequence number for each of the multicast packets.

2. The network of claim 1 wherein the identical MBS regions are transmitted synchronously by each of the base stations of the MBS zone and comprise time and frequency synchronized portions of an orthogonal frequency division multiple access (OFDMA) frame, and
wherein each base station of the MBS zone transmits the same multicast data on the same subcarriers and at the same times within the MBS region.

3. The network of claim 2 wherein the current timestamp indicates a future transmission time of a current multicast packet,
wherein the next timestamp indicates a subsequent future transmission time of a next multicast packet, and
wherein the next timestamp is provided to the mobile station in an MBS map portion of the MBS zone, allowing a mobile station to remain in idle mode until the time indicated by the next timestamp.

4. The network of claim 3 wherein the MBSC operates within a gateway of an access service network (ASN) to aggregate the multicast packets with common multicast CIDs in the shim layer for providing to the base stations, and
wherein the network further includes an authentication authorization accounting server with a policy function to provide authorization for mobile stations to receive multicast broadcast services in response to requests from the MBSC.

5. The network of claim 4 wherein the MBSC provides a multicast internet-protocol (IP) address to the MBSAs of the base stations of the MBS zone to set-up a local IP multicast group, and
wherein the MBSC transmits the multicast data to the base stations of the MBS zone using the multicast IP address.

6. The network of claim 4 wherein the MBSC is one of a plurality of MBSCs that are part of a multicast IP group that receive broadcast content from one or more content servers.

7. The network of claim 1 wherein the multicast data comprises a plurality of broadcast channels from various content servers.

8. The network of claim 2 wherein the mobile stations use diversity gain to receive the identical MBS regions within downlink subframes from at least two or more of the base stations within the MBS zone for improved reception.

9. The network of claim 2 wherein the MBSC increases a size of the MBS regions when additional multicast data is to be transmitted by the base stations of the MBS zone,
wherein the MBSC decreases the size of the MBS regions when less multicast data is to be transmitted by the base stations of the MBS zone, and
wherein the size of the MBS zone is defined by a number of time-slots and subchannels within the OFDMA frame.

10. The network of claim 2 further comprising one or more non-single-frequency network (SFN) base stations that transmit the multicast data non-synchronously with the base stations outside the MBS zone.

11. A method of providing multicast broadcast service (MBS) in a wireless access network comprising:
creating, by a multicast broadcast service controller (MBSC), an MBS zone comprising a plurality of base stations by establishing time and frequency parameters for simultaneous multicast downlink transmissions to mobile stations within the MBS zone;
synchronously transmitting, by a multicast broadcast service agent (MBSA) within each of the base stations, identical MBS regions within downlink subframes by the base stations of the MBS zone, the identical MBS regions including multicast data identified by multicast connection identifiers (CIDs); and
adding, by the MBSC, a shim layer to multicast packets received from content servers, the shim layer to include a multicast CID, a current timestamp, a next timestamp, and a packet sequence number for each of the multicast packets.

12. The method of claim 11 wherein the identical MBS regions are transmitted synchronously by each of the base stations of the MBS zone and comprise time and frequency synchronized portions of an orthogonal frequency division multiple access (OFDMA) frame, and
wherein the method further comprises transmitting by each base station of the MBS zone the same multicast data on the same subcarriers and at the same times within the MBS region.

13. The method of claim 11 wherein the current timestamp indicates a future transmission time of a current multicast packet,
wherein the next timestamp indicates a subsequent future transmission time of a next multicast packet,
wherein the next timestamp is provided to the mobile station in an MBS map portion of the MBS zone, allowing a mobile station to remain in idle mode until the time indicated by the next timestamp, and
wherein the MBSA uses the sequence number, the current timestamp and the multicast CID to generate the identical MBS regions within the downlink subframes for receipt by the mobile stations.

14. The method of claim 13 wherein the MBSC operates within a gateway of an access service network (ASN) to aggregate the multicast packets with common multicast CIDs in the shim layer for providing to the base stations,
wherein the method further comprises:
providing, by the MBSC, a multicast internet-protocol (IP) address to the MBSAs of the base stations of the MBS zone to set up a local IP multicast group; and
transmitting, by the MBSCs, the multicast data to the base stations of the MBS zone using the multicast IP address.

15. The method of claim 11 further comprising providing authorization by an authentication authorization accounting server with a policy function for mobile stations to receive multicast broadcast services in response to requests from the MBSC.

16. The method of claim 12 wherein the mobile stations use diversity gain to receive the identical MBS regions within downlink subframes from at least two or more of the base stations within the MBS zone for improved reception.

17. The method of claim 12 further comprising:
increasing a size of the MBS regions when additional multicast data is to be transmitted by the base stations of the MBS zone; and
decreasing the size of the MBS regions when less multicast data is to be transmitted by the base stations of the MBS zone,
wherein the size of the MBS zone is defined by a number of time-slots and subchannels within the OFDMA frame.

18. A method of internet-protocol (IP) multicasting in a wireless access network comprising:
receiving, at a serving base station, a request from a mobile station to join an existing multicast session;
requesting authorization from an authentication authorization accounting server with a policy function to provide authorization for the mobile station to receive multicast broadcast services (MBS);
transmitting from the serving base station, a dynamic service addition request to the mobile station, the dynamic service addition request including a multicast CID and a multicast zone identifier; and
transmitting IP multicast data encapsulated with the multicast CID.

19. The method of claim 18 wherein the request to join is received on an open data connection identifier (CID) and includes a multicast IP address of the existing multicast session the mobile station is requesting to join.

20. The method of claim 19 wherein the request to join is a network layer communication at layer 3 (L3).

21. The method of claim 18 wherein the request to join includes an MBS message type-length-value (TLV) to indicate the existing multicast session the mobile station is requesting to join.

22. The method of claim 21 wherein the request to join is a dynamic link layer (DLL) communication at layer 2 (L2).

23. The method of claim 18 further comprising receiving, in response to the dynamic service addition request, a dynamic service addition response from the mobile station.

24. The method of claim 18 further comprising adding a shim layer to multicast packets received from content servers, the shim layer to include a multicast CID, a current timestamp, a next timestamp, and a packet sequence number for each of the multicast packets.

25. The method of claim 24 wherein the current timestamp indicates a future transmission time of a current multicast packet,
wherein the next timestamp indicates a subsequent future transmission time of a next multicast packet, and
wherein the next timestamp is provided to the mobile station in an MBS map portion of the MBS zone allowing a mobile station to remain in idle mode until the time indicated by the next timestamp.
